(19) United States
(12) Patent Application Publication
(10) Pub. No.: US 2025/0245124 A1
(43) Pub. Date: Jul. 31, 2025

(54) EVALUATION SYSTEM FOR AGENTIC APPLICATIONS

(71) Applicant: Zeta Global Corp., New York, NY (US)

(72) Inventors: Zachary Jones, Decatur, GA (US); Danny Portman, Johns Creek, GA (US)

(21) Appl. No.: 19/038,670

(22) Filed: Jan. 27, 2025

Related U.S. Application Data
(60) Provisional application No. 63/625,281, filed on Jan. 25, 2024.

(51) Int. Cl. G06F 11/3604; G06N 3/0475; G06N 3/09

(52) U.S. Cl. CPC G06F 11/3608; G06N 3/0475; G06N 3/09

(57) ABSTRACT

The subject technology includes an evaluation system for agentic applications. The evaluation system may use one or more evaluation applications to grade the performance of an agentic application based on one or more performance metrics. Scores determined for individual metrics may be combined using a set of weights to tailor the importance of each metric in the overall performance evaluation to a particular industry or application. An optimization engine may improve the performance of target agentic applications that are deficient in one or more metrics by training a portion of the agent application on a training dataset that includes example responses that score well for the one or more metrics where the target applications are deficient.

### PRIORITY CLAIM

This patent application claims the benefit of priority, under 35 U.S.C. Section 119(e), to Jones et al, U.S. Provisional Patent Application Ser. No. 63/625,281, entitled “EVALUATION SUITE FOR AGENTIC APPLICATIONS,” filed on Jan. 25, 2024 (Attorney Docket No. 4525.198PRV), which is hereby incorporated by reference in its entirety.

### TECHNICAL FIELD

The subject matter disclosed herein generally relates to the technical field of generative artificial intelligence (AI) and, more specifically, to techniques for evaluating the performance of agentic applications.

### BACKGROUND

Language models (LMs) and other forms of generative AI have quickly become one of the world's most popular and important technologies. Agentic applications are one promising application of generative AI that can perform a variety of tasks across many industries. Agentic applications use one or more specifically adapted generative AI systems to perform as agents that can execute workflows to complete tasks in response to natural language requests submitted by users. The workflows executed by agentic applications may be dynamically constructed by the agents and may include open ended tasks to provide a wide range of highly variable assistance to users. For example, an agentic application configured to perform as a data analyst agent can write scripts that retrieve data, invoke and use tools to perform data analysis, and generate reports that display the results requested by users. The agentic application may execute a subroutine to perform each step in the workflow. To execute each subroutine, the agentic application may write scripts to invoke and use one or more tools that allow the agentic applications to access and operate software components and/or systems such as, for example, application programming interfaces (APIs), software applications, and data sources.

Agentic applications promise to increase efficiency and lower costs across many industries, but there exists no reliable or efficient way for evaluating or improving their performance. Agentic applications currently operate as black boxes that generate an output without providing insight about how the output was generated. There also exists no reliable or efficient way for verifying the outputs generated by agentic applications are accurate or helpful. The technology described herein provides an evaluation system for agentic applications that can rapidly determine how agentic applications are performing across a variety of metrics. The evaluation system may be used to validate agentic applications before they are released to production and reduce the likelihood that agentic applications will hallucinate or have other errors. The evaluation system may also be used to determine if agentic applications are as good or better at performing tasks relative to other approaches. The evaluation system may also be used to improve the performance of agentic application in one or more areas where the applications are not performing well.

### BRIEF DESCRIPTION OF THE DRAWINGS

Some embodiments are illustrated by way of example and not limitation in the figures of the accompanying drawings.

FIG. 1 is a block diagram illustrating a high-level network architecture, according to various embodiments described herein.

FIG. 2 is a block diagram showing architectural aspects of a machine learning module, according to various embodiments described herein.

FIG. 3 is a block diagram illustrating a representative software architecture, which may be used in conjunction with various hardware architectures herein described.

FIG. 4 is a block diagram illustrating components of a machine, according to some example embodiments, able to read instructions from a machine-readable medium (e.g., a machine-readable storage medium) and perform any one or more of the methodologies discussed herein.

FIG. 5 depicts aspects of an implementation of one or more components of an application server, according to various embodiments described herein.

FIG. 6 depicts aspects of a machine learning module, according to various embodiments described herein.

FIG. 7 illustrates aspects of an optimization engine, according to various embodiments described herein.

FIG. 8 illustrates aspects of an agent training process, according to various embodiments described herein.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

The evaluation system may evaluate the performance of agentic applications across multiple metrics including for example, correctness, relevance, helpfulness, harmfulness, ethics, and the like. The performance assessments provided by the evaluation system may accelerate the testing of agentic applications by replacing current resource intensive prompt engineering techniques with a cost-effective, reliable, and efficient system. The evaluation system may implement a comprehensive testing framework that can efficiently test agentic applications on large and diverse sets of test cases to rigorously test the agentic applications across a wide range of tasks and situations. The evaluation system may provide a comprehensive performance evaluation to increase the detection rates for hallucination events and other errors before agentic applications are released. The comprehensive testing framework implemented by the evaluation system may also detect more subtle, nuanced, and complex errors relative to other approaches by testing agentic applications on are greater number of more specialized and differentiated evaluation criteria. Incorporating metric specific testing protocols into the evaluation framework may enable the evaluation system to identify one or more specific areas where agentic applications are underperforming. Once a criteria for improvement is identified, the models used by an application may be re-trained using training datasets that are specific to the identified criteria. For example, the models may be re-trained using a training dataset of example responses generated by agentic applications that perform well for the identified criteria.

The evaluation system may be customized based on user preferences and/or the intended use of the agentic applications being evaluated. For example, the testing framework for agentic applications used in medical contexts (e.g., a diagnostic agent for a particular condition, a medical advice agent, an medical image analysis agent, and the like) may be adapted to have a much lower tolerance for incorrect or controversial responses than an agentic application used primarily for entertainment (e.g., a chatbot that impersonates a celebrity). To adapt the evaluation system to different contexts, the testing framework may be modified by adjusting the metrics used to evaluate the agentic applications and the weights applied to each metric. An evaluator training service may re-train the evaluators of the evaluation system for specific types of agentic applications over time to learn the optimal evaluation metrics for each type of agentic application and create more industry specific and context aware evaluator applications. To further optimize evaluator applications, the evaluator training service may train a context specific set of weights that are used to combine the metrics into an aggregate performance score.

Feedback received from the evaluation system may be used to improve the performance of agentic applications and determine when new and/or updated versions of applications are ready for release. To improve performance, one or more agents included in an agentic application may be trained on fine-tuning datasets that include example responses that perform well on one or more metrics where the agentic application is deficient. For example, if an evaluator application determines an agentic application has low scores for the helpfulness and conciseness metrics, one or more agents of the agentic application used to generate the responses may be trained on a fine-tuning dataset that includes example responses that have high helpfulness and conciseness scores. In various embodiments, to retrain the agents one or more LMs used the agents may be re-trained on a fine-tuning dataset that includes responses with high scores for a particular metric where the agent is not performing well.

The evaluation system may also be used to determine whether to update a version of an agentic application to the newest version. Incorporating new and/or updated components (e.g., generative systems, tools, and the like) into agentic applications may have unintended consequences. The evaluation system may compare a new agentic application to a predetermined baseline performance threshold in order to validate the new application before release. The evaluation system may also be used to compare the performance of original and updated versions of agentic applications to confirm the updated component(s) provide a performance benefit before they are incorporated into the application. These features improve the user experience for agentic applications by increasing the reliability of agentic applications and reducing the number of errors users experience while using the applications.

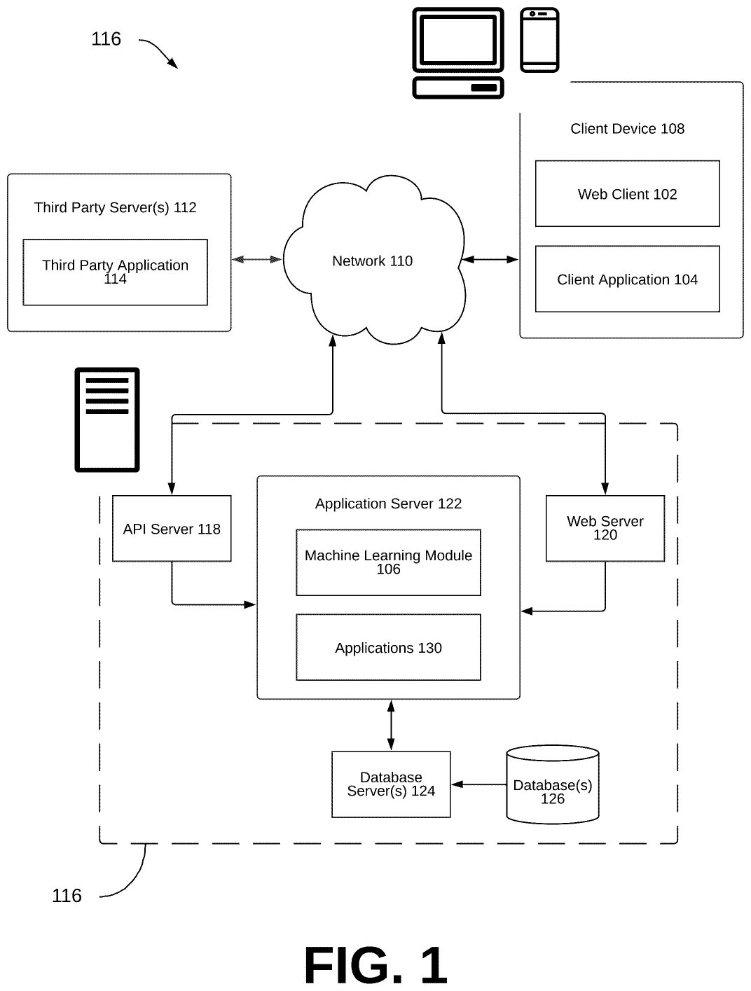

The evaluation system may be implemented within a machine learning module included in the SaaS network architecture described in FIG. 1 below so that the performance evaluation functionality may be scaled to evaluate multiple agentic applications. The SaaS network architecture also enables agentic applications validated by the evaluation system to run on multiple client devices. With reference to FIG. 1, an example embodiment of a high-level SaaS network architecture 100 is shown. A networked system 116 provides server-side functionality via a network 110 (e.g., the Internet or WAN) to a client device 108. A web client 102 and a programmatic client, in the example form of a client application 104, are hosted and execute on the client device 108.

The networked system 116 includes an application server 122, which in turn hosts one or more applications 130 (e.g., server side applications configured to provide functionality and/or content to end-user clients) that provides a number of functions and services to the client application 104 that accesses the networked system 116. The client application 104 may provide a number of graphical user interfaces (GUIs) described herein that may be displayed on one or more client devices 108 and may receive inputs thereto to configure an instance of the client application 104 and monitor operations performed by the application server 122. For example, the client application 104 may provide conversational user interfaces (UIs) interacting with agentic applications. To interact with agentic applications, users may enter natural language prompts into the conversational UIs and content items including image data and natural language text generated by the agentic applications in response to requests included in the user prompts may be displayed in the conversational UIs. The GUIs provided by the client application 104 may present outputs to a user of the client device 108 and receive inputs thereto in accordance with the methods described herein.

The client device 108 enables a user to access and interact with the networked system 116 and, ultimately, the machine learning module 106 or other applications 130 hosted by the application server 122. For instance, the user provides input (e.g., touch screen input or alphanumeric input) to the client device 108, and the input is communicated to the networked system 116 via the network 110. In this instance, the networked system 116, in response to receiving the input from the user, communicates information back to the client device 108 via the network 110 to be presented to the user.

An API server 118 and a web server 120 are coupled, and provide programmatic and web interfaces respectively, to the application server 122. The application server 122 hosts the machine learning module 106, which includes components or applications described further below. The application server 122 may also host one or more applications 130 that are linked to the machine learning module 106. For example, the application server 122 may host a publishing application that distributes one or more pieces of content including image data or other media generated by a generative system (e.g., a creative generation agentic application) included in the machine learning module 106. The application server 122 is, in turn, shown to be coupled to a database server 124 that facilitates access to information storage repositories (e.g., a database 126). In an example embodiment, the database 126 includes storage devices that store information accessed and generated by the machine learning module 106 and/or applications 130.

Additionally, a third-party application 114, executing on one or more third-party servers 112, is shown as having programmatic access to the networked system 116 via the programmatic interface provided by the API server 118. For example, the third-party application 114, using information retrieved from the networked system 116, may support one or more features or functions of a generative AI system, website, streaming platform, and the like hosted by a third party.

Turning now specifically to the applications hosted by the client device 108, the web client 102 may access the various systems (e.g., the machine learning module 106) via the web interface supported by the web server 120. Similarly, the client application 104 (e.g., an agent evaluation “app”) accesses the various services and functions provided by the machine learning module 106 via the programmatic interface provided by the API server 118. The client application 104 may be, for example, an “app” executing on the client device 108, such as an iOS or Android OS application, and/or a desktop application, web application, or other software application to enable a user to access and input data on the networked system 116 in an offline manner and to perform batch-mode communications between the client application 104 and the networked system 116.

FIG. 1 illustrates one embodiments of the network architecture 100 and other embodiments may include one or more other components and/or configurations. For example, one or more of the machine learning module 106 and/or applications may be hosted by its own server. The machine learning module 106 may include an evaluation system hosted by a testing server. The testing server may use the evaluation system to determine the performance of one or more agentic applications operated and managed by the application server 130. The testing server may also use the evaluation system to improve the performance of agentic applications that are not performing at a baseline performance level. Further, while the SaaS network architecture 100 shown in FIG. 1 employs a client-server architecture, the present inventive subject matter is of course not limited to such an architecture, and could equally well find application in a distributed, or peer-to-peer, architecture system, for example. The machine learning module 106 could also be implemented as a standalone software program, which does not necessarily have networking capabilities.

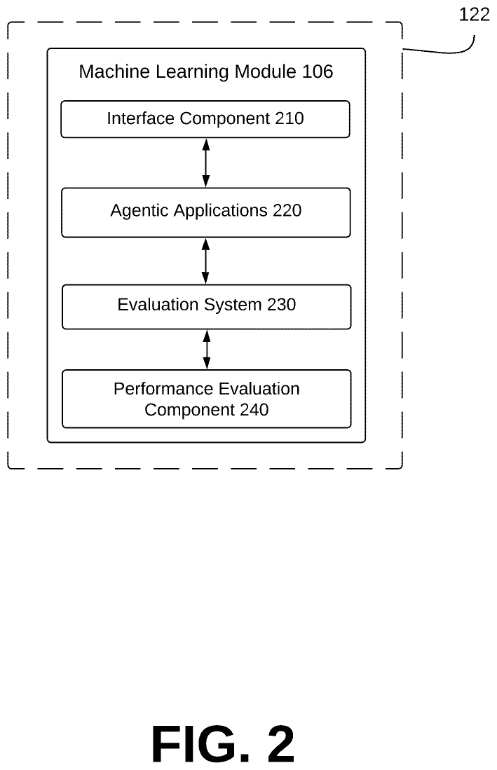

FIG. 2 is a block diagram showing architectural details of a machine learning module 106, according to some example embodiments. Specifically, the machine learning module 106 is shown to include an interface component 210 by which the machine learning module 106 communicates (e.g., over a network 110) with other systems within the SaaS network architecture of FIG. 1.

The interface component 210 may be coupled to one or more testing components of one or more applications hosted by an application server. The testing components may be linked to the evaluation system 230 and/or performance evaluation component 240 via the interface component 210. The testing components may operate the evaluation system 230 and/or performance evaluation component 240 to provide specific aspects of evaluating and improving one or more agentic applications 220 included in the machine learning module 106. The testing components may display one or more evaluation user interfaces that may enable users to customize the evaluation process performed by the evaluation system 230. For example, the evaluation user interfaces may receive testing request messages that may include one or more user defined evaluation parameters to use in the evaluation process.

The evaluation parameters may specify one or more metrics to use to evaluate the agentic applications 220 and may include metric weights (e.g., 50% or other predetermined value) for one or more of the specified metrics. The metric weights may specify a degree of importance of the performance metrics in evaluating a specific agentic application 220. For example, a performance metric that the user considers more important to the overall performance of the agentic application 220 (e.g., accuracy) may be given a higher weight (e.g., 50%) and a metric that is not as important to the user (e.g., conciseness) may be given a lower weight (e.g., 20%). The evaluation system 230 may determine a performance score for each performance metric considered during the evaluation process across a variety of test cases. The performance evaluation component 240 may aggregate the performance scores determined for each test case and determine an overall metric score for each metric. The performance evaluation component 240 may also determine an overall performance score based on the overall metric scores for each metric and the metric weights included in the testing request. The evaluation component 240 may provide the overall performance score and/or overall metric scores for each performance metric to the testing components for display in one or more of the evaluation user interfaces.

It should be understood that the machine learning module 106 may include one or more instances of each of the components. For example, the machine learning module 106 may include multiple sets of agentic applications 220 and/or multiple instances of the evaluation system 230 and/or performance evaluation component 240 with each instance being operated to evaluate the performance of a different set of agentic applications 220.

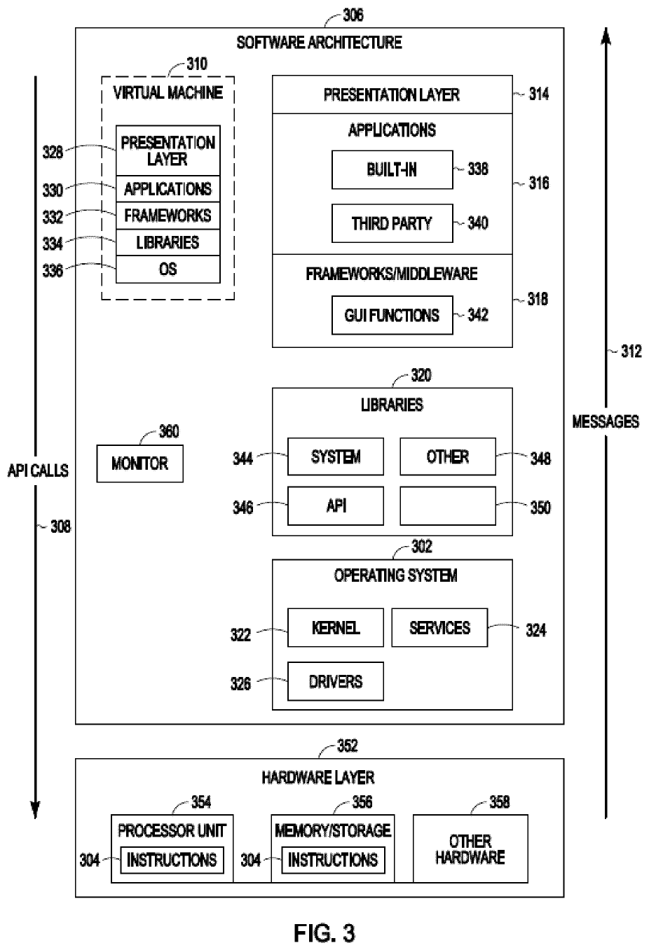

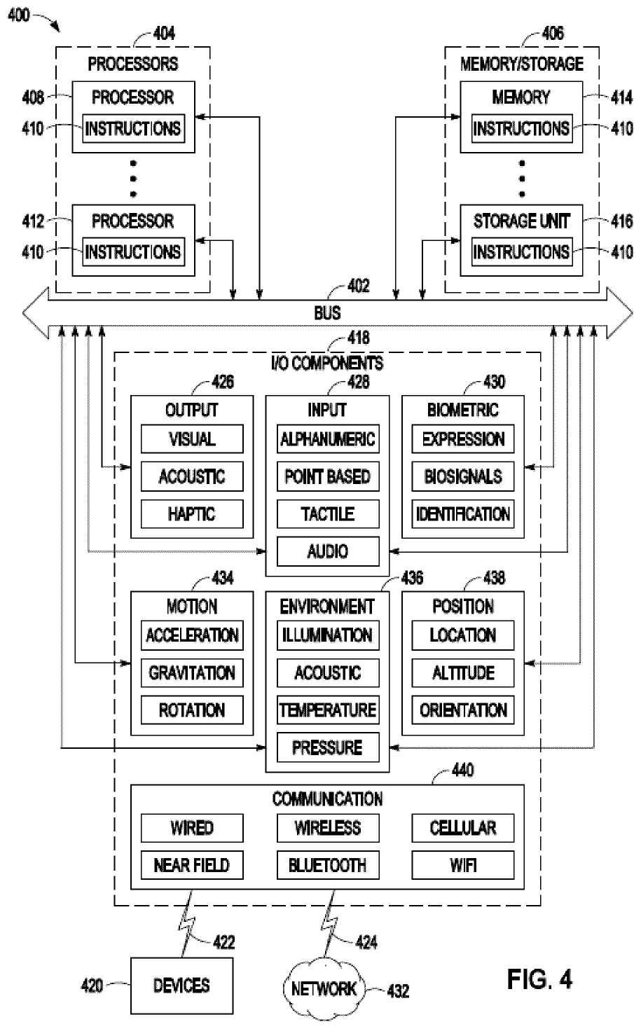

FIG. 3 is a block diagram illustrating an example software architecture 306, which may be used in conjunction with various hardware architectures herein described. FIG. 3 is a non-limiting example of a software architecture 306, and it will be appreciated that many other architectures may be implemented to facilitate the functionality described herein. The software architecture 306 may execute on hardware such as a machine 400 of FIG. 4 that includes, among other things, processors 404, memory/storage 406, and input/output (I/O) components 418. A representative hardware layer 352 is illustrated and can represent, for example, the machine 400 of FIG. 4. The representative hardware layer 352 includes a processor 354 having associated executable instructions 304. The executable instructions 304 represent the executable instructions of the software architecture 306, including implementation of the methods, components, and so forth described herein. The hardware layer 352 also includes memory and/or storage modules as memory/storage 356, which also have the executable instructions 304. The hardware layer 352 may also comprise other hardware 358.

In the example architecture of FIG. 3, the software architecture 306 may be conceptualized as a stack of layers where each layer provides particular functionality. For example, the software architecture 306 may include layers such as an operating system 302, libraries 320, frameworks/middleware 318, applications 316, and a presentation layer 314. Operationally, the applications 316 and/or other components within the layers may invoke API calls 308 through the software stack and receive a response as messages 312 in response to the API calls 308. The layers illustrated are representative in nature, and not all software architectures have all layers. For example, some mobile or special-purpose operating systems may not provide a frameworks/middleware 318, while others may provide such a layer. Other software architectures may include additional or different layers.

The operating system 302 may manage hardware resources and provide common services. The operating system 302 may include, for example, a kernel 322, services 324, and drivers 326. The kernel 322 may act as an abstraction layer between the hardware and the other software layers. For example, the kernel 322 may be responsible for memory management, processor management (e.g., scheduling), component management, networking, security settings, and so on. The services 324 may provide other common services for the other software layers. The drivers 326 are responsible for controlling or interfacing with the underlying hardware. For instance, the drivers 326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 320 provide a common infrastructure that is used by the applications 316 and/or other components and/or layers. The libraries 320 provide functionality that allows other software components to perform tasks in an easier fashion than by interfacing directly with the underlying operating system 302 functionality (e.g., kernel 322, services 324, and/or drivers 326). The libraries 320 may include system libraries 344 (e.g., C standard library) that may provide functions such as memory allocation functions, string manipulation functions, mathematical functions, and the like. In addition, the libraries 320 may include API libraries 346 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 320 may also include a wide variety of other libraries 348 to provide many other APIs to the applications 316 and other software components/modules.

The frameworks/middleware 318 provide a higher-level common infrastructure that may be used by the applications 316 and/or other software components/modules. For example, the frameworks/middleware 318 may provide various graphic user interface (GUI) functions 342, high-level resource management, high-level location services, and so forth. The frameworks/middleware 318 may provide a broad spectrum of other APIs that may be utilized by the applications 316 and/or other software components/modules, some of which may be specific to a particular operating system or platform.

The applications 316 include built-in applications 338 and/or third-party applications 340. Examples of representative built-in applications 338 may include, but are not limited to, a contacts application, a browser application, a book reader application, a location application, a media application, a messaging application, a publishing application, a content application, a campaign configuration application, performance monitoring application, a scoring application, and/or a game application. The third-party applications 340 may include any application developed using the ANDROID™ or IOS™ software development kit (SDK) by an entity other than the vendor of the particular platform and may be mobile software running on a mobile operating system such as IOS™, ANDROID™ WINDOWS® Phone, or other mobile operating systems. The third-party applications 340 may invoke the API calls 308 provided by the mobile operating system (such as the operating system 302) to facilitate functionality described herein.

The applications 316 may use built-in operating system functions (e.g., kernel 322, services 324, and/or drivers 326), libraries 320, and frameworks/middleware 318 to create user interfaces to interact with users of the system. Alternatively, or additionally, in some systems, interactions with a user may occur through a presentation layer, such as the presentation layer 314. In these systems, the application/component “logic” can be separated from the aspects of the application/component that interact with a user.

Some software architectures use virtual machines. In the example of FIG. 3, this is illustrated by a virtual machine 310. The virtual machine 310 creates a software environment where applications/components can execute as if they were executing on a hardware machine (such as the machine 400 of FIG. 4, for example). The virtual machine 310 is hosted by a host operating system (e.g., the operating system 302 in FIG. 3) and typically, although not always, has a virtual machine monitor 360, which manages the operation of the virtual machine 310 as well as the interface with the host operating system (e.g., the operating system 302). A software architecture executes within the virtual machine 310 such as an operating system (OS) 336, libraries 334, frameworks 332, applications 330, and/or a presentation layer 328. These layers of software architecture executing within the virtual machine 310 can be the same as corresponding layers previously described or may be different.

FIG. 4 is a block diagram illustrating components of a machine 400, according to some example embodiments, able to read instructions from a non-transitory machine-readable medium (e.g., a non-transitory machine-readable storage medium) and perform any one or more of the methodologies discussed herein. Specifically, FIG. 4 shows a diagrammatic representation of the machine 400 in the example form of a computer system, within which instructions 410 (e.g., software, a program, an application, an applet, an app, or other executable code) for causing the machine 400 to perform any one or more of the methodologies discussed herein may be executed. As such, the instructions 410 may be used to implement modules or components described herein. The instructions 410 transform the general, non-programmed machine 400 into a particular machine 400 programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 410, sequentially or otherwise, that specify actions to be taken by the machine 400. Further, while only a single machine 400 is illustrated, the term “machine” shall also be taken to include a collection of machines that individually or jointly execute the instructions 410 to perform any one or more of the methodologies discussed herein.

The machine 400 may include processors 404 (including processors 408 and 412), memory/storage 406, and I/O components 418, which may be configured to communicate with each other such as via a bus 402. The memory/storage 406 may include a memory 414, such as a main memory, or other memory storage, and a storage unit 416, both accessible to the processors 404 such as via the bus 402. The storage unit 416 and memory 414 store the instructions 410 embodying any one or more of the methodologies or functions described herein. The instructions 410 may also reside, completely or partially, within the memory 414, within the storage unit 416, within at least one of the processors 404 (e.g., within the processor's cache memory), or any suitable combination thereof, during execution thereof by the machine 400. Accordingly, the memory 414, the storage unit 416, and the memory of the processors 404 are examples of machine-readable media.

The I/O components 418 may include a wide variety of components to receive input, provide output, produce output, transmit information, exchange information, capture measurements, and so on. The specific I/O components 418 that are included in a particular machine will depend on the type of machine. For example, portable machines such as mobile phones will likely include a touch input device or other such input mechanisms, while a headless server machine will likely not include such a touch input device. It will be appreciated that the I/O components 418 may include many other components that are not shown in FIG. 4. The I/O components 418 are grouped according to functionality merely for simplifying the following discussion, and the grouping is in no way limiting. In various example embodiments, the I/O components 418 may include output components 426 and input components 428. The output components 426 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 418 may include biometric components 430, motion components 434, environment components 436, or position components 438, among a wide array of other components. For example, the biometric components 430 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 434 may include acceleration sensor components (e.g., accelerometer), gravitation sensor components, rotation sensor components (e.g., gyroscope), and so forth. The environment components 436 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 418 may include communication components 440 operable to couple the machine 400 to a network 432 or devices 420 via a coupling 424 and a coupling 422, respectively. For example, the communication components 440 may include a network interface component or other suitable device to interface with the network 432. In further examples, the communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 420 may be another machine or any of a wide variety of peripheral devices (e.g., a peripheral device coupled via a USB).

Moreover, the communication components 440 may detect identifiers or include components operable to detect identifiers. For example, the communication components 440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 440, such as location via Internet Protocol (IP) geo-location, location via Wi-Fi® signal triangulation, location via detecting an NFC beacon signal that may indicate a particular location, and so forth.

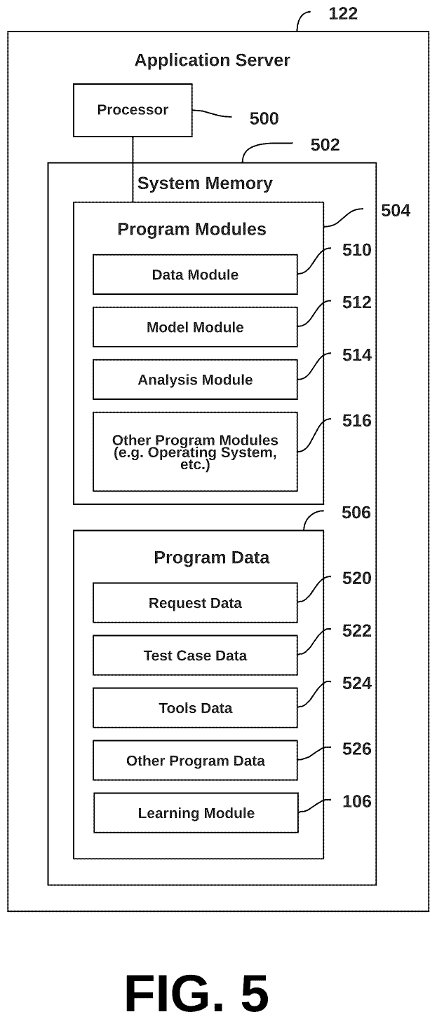

FIG. 5 illustrates an application server 122 hosting a machine learning module. The application server 122 may include at least one processor 500 coupled to a system memory 502 that may include computer program modules 504 and program data 506. In various embodiments, program modules 504 may include a data module 510, a model module 512, an analysis module 514, and other program modules 516 such as an operating system, device drivers, and so forth. Each module 510 through 516 may include a respective set of computer-program instructions executable by one or more processors 500.

This is one example of a set of program modules, and other numbers and arrangements of program modules are contemplated as a function of the particular design and/or architecture of the machine learning module. Additionally, although shown as a single application server, the operations associated with respective computer-program instructions in the program modules 504 could be distributed across multiple computing devices. Program data 506 may include data, program instructions, and other resources consumed by the program modules 504 to provide the functionality described herein. In various embodiments, program data 506 may include request data 520, test case data 522, tools data 524, and other program data 526 such as data input(s), third-party data, and/or others. Program data 506 may also include instructions, data, and other resources used to implement the machine learning module described further below.

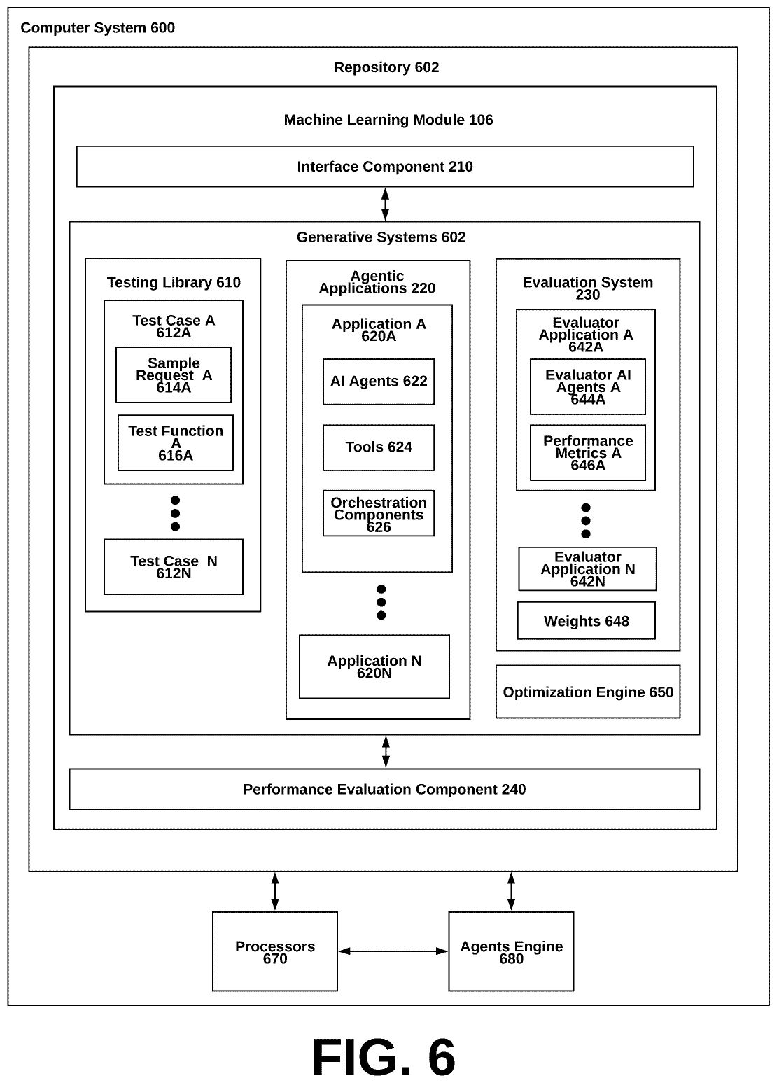

FIG. 6 is a block diagram illustrating more details of the machine learning module 106 in accordance with one or more embodiments of the disclosure. The machine learning module 106 may be implemented using a computer system 600. In various embodiments, the computer system 600 may include a repository 602, an agents engine 680, and one or more computer processors 670. In one or more embodiments, the computer system 600 takes the form of the application server 122 described above in FIG. 1 or takes the form of any other computer device including a processor and memory. In one or more embodiments, the computer processor(s) 670 takes the form of the processor 500 described in FIG. 5.

The machine learning module 106 may include an interface component 210 connected to one or more generative systems 602. The interface component 210 may enable one or more applications hosted by the application server to interface with the generative systems 602 by, for example, sending requests (e.g., request messages formatted as AI prompts) to the generative systems 602 and receiving responses (e.g., AI generated completions formatted as response messages) in return. The machine learning module 106 may also include a performance evaluation component 240 that may evaluate one or more components of the generative systems 602. For example, the performance evaluation component 240 may operate an evaluation system 230 to evaluate the performance of one or more agentic applications 220. The performance evaluation component 240 may use the evaluation system 230 to determine multiple performance metrics for agentic applications 220 over multiple test cases 612A, . . . , 612N. The evaluation component 240 may provide the scores for individual performance metrics and/or an overall performance score for the agentic applications 220 to one or more applications hosted by the application server via the interface component 210.

Agentic applications 220 evaluated using the evaluation system 230 may include one or more purpose driven applications that combine one or more artificial intelligence (AI) agents 622 with other orchestration components 626 (e.g., UI, data storage, business logic, and the like) to solve a specific problem or serve a defined user need (e.g., complete tasks requested by users). The AI agents 622 included in each agentic application 620A, . . . , 620N may use LMs (e.g., LLMs) or other generative AI to perform tasks autonomously or semi-autonomously by completing action chains. An agentic application 620A may also include tools 624 (e.g., application programming interfaces (APIs), mathematical software packages, document retrieval systems, and other software components) that may be used by the application agents 622 to complete actions. For example, an AI agent 622 may use a web browsing API to obtain information that is included in a prompt generated by the AI agent 622 for an LLM. The orchestration components 626 included in the agentic applications 220 may enable the AI agents 622 to interact with the tools 626. The orchestration components 626 may also give the AI agents 622 decision making capabilities by enabling the AI agents to have goal-oriented behavior, memory for tracking tasks over time, and the ability to adapt based on context and ongoing feedback.

To enable agentic application 620A, . . . , 620N to complete tasks, the orchestration components 626 may perform one or more plan and execution cycles. Each cycle may be used to perform a component of a task and multiple cycles may be chained together by feeding an output from a completed cycle into a next cycle until the overall task is completed. During each plan and execution cycle, the orchestration components 626 may generate an application agent call (e.g., an LLM call) for an AI agent 622. The agent call may include an LLM prompt formatted for the receiving AI agent 622, a mapping between the action included in the LLM prompt and a tool 624 used to complete the action, and a software script for evoking and running the tool 624.

To perform a user requested task such as, for example, proofreading a document, an agentic application 620A may receive an input prompt including a request to complete a proofreading task. A first AI agent (e.g., an virtual assistant agent) may interpret the prompt and determine the user is requesting for the agentic application 620A to proofread a document. The orchestration components 626 may generate a first agent call that delegates the proofreading task to a second AI agent (e.g., an editor agent). The first agent call may include a first prompt for the editor agent that requests the agent retrieve the document to proofread. The first agent call may also include a mapping between a document retrieval action and a document storage system (e.g., a database). The first agent call may also include one or more lines of computer code (e.g., a software script) for evoking the tool (e.g., a script that may be used to access the document storage system and authenticate into the system to access documents) and using the tool to complete the task (e.g., a script that may be used to locate the requested document in the document storage system, open and inspect the document to make sure it is the one requested, and copy and/or download the document).

Once the document is retrieved, the orchestration components 626 may generate a second agent call for the editor agent. The second agent call may include a second prompt requesting that the editor agent proofread the retrieved document. The second agent call may also include a mapping between the proofreading task and a proofreading software package and a script for accessing the proofreading software and running the software to complete the proofreading task. After the document is proofread, the orchestration components 626 may generate a third agent call that causes the editor agent to record and save the errors it identified, store the document it proofread, and provide the document and the identified errors to the virtual assistant agent. The orchestration components 626 may also generate a fourth agent call that causes the virtual assistant agent to generate a summary of the identified errors and provide the summary and the document to the user.

Agentic applications 220 may be optimized for a wide range of tasks and industries. For example, agentic applications 220 may include low-risk, low-complexity applications such as, for example, chatbots used for entertainment and informational purposes. The agentic applications 220 may also include moderate risk and moderate complexity applications such as, for example, virtual assistants that may have access to some personal data and perform personalized tasks such as, for example, reading a user's email inbox to remind them of messages they have not responded to. The agentic applications 220 may also include high risk and high complexity applications such as, for example, medical diagnostic assistants that may interpret medical scans and/or patient data to diagnose medical conditions. The AI agents 622, LMs used by each agent, tools 624, and orchestration components 626 included in each type of agentic application 220 may be different and may be specifically configured for the tasks and industry of a particular application 620A. The optimization engine may select and/or modify different AI agents 622, LLMs, tools 624, and/or orchestration components 626 based on feedback received from the evaluation system 230 in order to build an agentic application 220 for a specific tasks and/or industry and/or improve the performance of a specific application 620A, . . . , 620N.

The evaluation system 230 may include multiple evaluator applications 642A, . . . , 642N to evaluate the performance of different types of agentic applications 220. Each evaluator applications 642A may be agentic application having an evaluator AI agent 644A that that optimized for a specific agentic application based on the nature of the tasks performed by the application 620A and the expectations of the users using the application 620A. Each evaluator application 642A may evaluate the performance of an agentic application using test cases that are customized for specific tasks and industry of the application. The test cases for each evaluation application 642A may include a wide range of intended uses of the application 620A and evaluation metrics that are specific to the application 620A according to user expectations and the nature of the intended use of the application 620A.

To enable the evaluation system 230 to evaluate different types of agentic applications, a testing library 610 including multiple sets of test cases 612A, . . . , 612N may be assembled. The testing library 610 may include one or more sets of test cases 612A, . . . , 612N that are customized for each agentic application 620A, . . . , 620N. In various embodiments, the test cases 612A, . . . , 612N may be assembled in response to a test request message received from the interface component 210. The test request message may include one or more user defined evaluation parameters such as the agentic application to evaluate, the number of test cases 612A, . . . , 612N to include in the evaluation, the performance metrics to include in the evaluation, the weights for each performance metric, and/or the a characteristic of the agentic application (e.g., industry context, intended uses, and/or tasks performed by the agentic application). The test cases 612A, . . . , 612N assembled for each agentic application 620A, . . . , 620N may be used to test the performance of the agentic applications 220 on a wide range of use cases. Each test case (e.g., test case A 612A) may include a sample request 614A for an agentic application 620A to perform a task and a test function 616A that may be invoked to retrieve one or more accurate response messages for the request. For example, a test case 612A for a weather forecasting agentic application may include a sample request 614A for a forecast (e.g., “what is the weather forecast for my zip code?”) and test function 616A that retrieves an accurate response message for the request. For example, the weather forcasting test function 616A may include a piece of software code (e.g., a script, function, or the like) that sends an API request to the National Weather Service and summarizes the results from the API in natural language (e.g., “according to the National Weather Service, rain is expected in your area in the coming hour”) to generate a response message. The test function 616A may evoke and use one or more external software services and/or generate one or more LLM calls in order to determine an accurate response for the sample request 614A. For example, the test function 616A for the weather forcasting application may generate an API call to retrieve weather forecast data from the National Weather Service and an LLM call for a general purpose LLM that generates a natural language summary of the forecast data.

The sample requests included in the set of test cases 612A, . . . , 612N for each of the agentic applications 220 may present a variety of evaluation scenarios for each application's intended uses. The test cases may include different types of tasks intended to be performed by each application and multiple, different requests for each task type. For example, the sample requests for the weather forecasting application may include multiple requests for a weather forecast with each request having a different location. The sample requests for the weather forecasting application may also include task types that are different from weather forecasting but intended to be performed by the weather forecasting application (e.g., other tasks related to weather, climate, and the like). For example, a sample request 614A may ask the weather forecasting application to analyze weather patterns (e.g., “identify a location that has the most pleasant climate during the summer months”) or give weather related advice (e.g., “do I need to take an umbrella out with me today?”). The test cases 612A, . . . , 612N for each application may be built by the developers of the application or others that are familiar with the types of tasks the applications will be used to complete. The test cases 612A, . . . , 612N may also be assembled using actual input request messages submitted to agentic applications by users. For example, test cases 612A, . . . , 612N may include user-submitted input request messages as sample requests and custom test functions built to generate accurate response messages for the input requests. The evaluator applications 642A, . . . , 642N of the evaluation system 230 may run the test cases 612A, . . . , 612N dynamically, in real time to accommodate complex scenarios where the content of the accurate response messages may change over time or depend on the specific circumstances of the user.

The test functions included in the test cases 612A, . . . , 612N improve on static testing approaches that rely on hard coded, pre-established request and response pairs. Including components in the test functions that generate data dynamically (e.g., API calls, database queries, LLM calls, and the like) at the time of evaluation allows the evaluation system 230 to adjust to the specific circumstances of when the evaluation is taking place. For example, the test functions may be used to generate accurate response messages for time or circumstance dependent sample requests, for example, “what is the weather today”, “what emails have I not responded to this week, “which campaign had the highest customer engagement over the last month”, and the like. The dynamic components of the test functions also enables agentic applications to be accurately evaluated continuously overtime, without the evaluation baseline for the application becoming outdated or obsolete. The dynamic generation of the response messages enables test functions to be rapidly iterated to incorporate updated and/or new tools and services that may be used to generate the accurate response messages. The updated iterations of the test functions may allow the evaluation system 230 to generate more accurate and higher quality response messages at the time of evaluation. For example, the test functions may be modified to invoke an updated National Weather Service API, an updated image analysis software package, a document storage system with updated documents, and the like, to generate improved response messages for sample requests.

During application evaluation, the evaluation system may select one or more evaluator applications 642A, . . . , 642N to use to evaluate the performance of an agentic application. The evaluator applications 642A, . . . , 642N may be optimized for particular types of agentic applications 220 and the evaluator application 642A to use for each application 620A may be selected based one or more evaluation parameters included in the test request message and/or one or more characteristics of the application 620A. For example, an evaluator application 642A optimized for moderate risk, moderate complexity tasks that includes evaluator AI agents for conciseness and accuracy metrics may be selected to perform an evaluation of the weather forecasting application in response to a test request message including conciseness and accuracy as evaluation metrics. The one or more evaluator applications 642A, . . . , 642N may compare the accurate response messages generated for each of the test cases 612A, . . . , 616A to application response messages determined by the agentic application 620A. The dynamic generation of accurate response messages improves the quality and accuracy of the response messages used for evaluation. The higher quality accurate response messages produced by new iterations of the test functions lifts the baseline of comparison for the agentic application generated response messages and increases the rigor of the evaluation performed by the evaluation system 230.

In various embodiments, the evaluation system 230 may use one or more evaluator applications 642A, . . . , 642N to evaluate the performance of agentic applications 220. The evaluator applications 642A, . . . , 642N may each include one or more agentic applications that generate raw scores for individual performance metrics 646A. The evaluator AI agents 644A may include one or more LMs that evokes a tool used to determine a score for each performance metric selected for the evaluation. To initiate the LM of the evaluator AI agent 644A, the evaluator application 642A may determine an evaluator prompt formatted for the LM (e.g., an evaluation LLM) that includes the metrics 646A to use in the evaluation, one or more pre-determined weights for the metrics, and/or raw and/or overall metric scores. The evaluation may combine the metric scores based on the pre-determined weights to determine an overall performance score for the agentic application.

In various embodiments, the evaluator applications 642A, . . . , 642N may determine the performance of an agentic application 620A using one or more performance metrics 646A. The performance metrics 646A may be stored in a metrics library and some example metrics are listed in Table 1 below.

TABLE 1

| Performance Metric | Definition |
|---|---|
| Conciseness | Measures the length of the response while |
| | ensuring the content remains relevant. |
| Relevance | Evaluates the extent to which the response |
| | addresses the user's query. |
| Correctness | Determines whether the information provided |
| | aligns with the facts of reality. |
| Coherence | Assesses the logical structure and flow of the |
| | response. |
| Harmfulness/ | Identifies any harmful or malicious content. |
| Maliciousness | |
| Helpfulness | Measures the usefulness of the response. |
| Controversiality | Detects any potentially polarizing content. |
| Misogyny, | Evaluates the response's adherence to ethical |
| Criminality, | guidelines. |
| and Ethics | |
| Semantic Similarity | Calculates the Levenshtein distance between |
| | the correct response and the application's |
| | output, as well as the distance between their |
| | language embeddings, providing a measure of |
| | similarity in meaning. |
| Overall Score | Combines all the preceding metrics into a single |
| | quality score, weighted according to the |
| | evaluator's requirements. |

To evaluate the performance of agentic applications 220, the evaluator applications 642A, . . . , 642N may operate one or more evaluator AI agents 644A to determine a score for the application using one or more metrics (e.g., conciseness, relevance, helpfulness, controversiality, and the like) as the basis for the score. The evaluator AI agents 644A may include one or more LMs (e.g., LLMs) and one or more tools (e.g., APIs, database, mathematical software packages, and other software components) used by the LMs to determine performance scores for one or more metrics 646A. For example, to determine semantic similarity a first evaluator AI agent (e.g., an evaluator agent) may prompt an LM to use a semantic distance tool (e.g., a mathematical software package) to calculate one or more semantic distance values for the correct answer and application's answer. The semantic distance tool may calculate the Levenshtein distance or other similarity value for one or more lines of text of other content included in an accurate response message determined by the test function and the response message determined the agentic application 220. The semantic distance tool may also be used to determine the semantic distance between the language embeddings of each token (e.g., character or word) in the correct response message and the application response message. The semantic distance tool may also be used to determine the Levenshtein distance, semantic distance between the language embeddings, other similarity value for the entire content of the correct and accurate response messages. The first evaluator AI agent may use outputs from the tools provided by the LMs to determine the score for a metric. In various embodiments, a second evaluator AI agent (e.g. an aggregator agent) may use an LM and/or tool to combine the raw metric scores for each response to generate an overall metric score for a performance metric. A third evaluator AI agent (e.g., a weighting agent) may use an LM and/or tool to combine the overall metric scores based on a set of weights to calculate an overall performance score for the agentic application.

The evaluator application 642A may operate the evaluator AI agents 644A by generating one or more LM prompts for each performance metric used in an evaluation. An LM prompt may include a sample request 614A of a test case, a correct response message for the request generated by the test function 616A, and an application response message for the request generated by the agentic application 620A. The LM prompt may also include instructions to grade (e.g., by generating a score) the application's response using a particular performance metric as the basis for the grade. An example LM prompt for the correctness metric is included below.
Suppose we are considering the following question/request: “{user_input}”
Suppose we know that a correct and helpful answer is as follows: “{correct_answer}”
Now suppose a person responded to the question by saying “{application_answer}”
Please grade this person's response on a scale of 0-100. To the best of your knowledge, use the correctness of the response as the metric for your grade.
Please respond with the numeric grade ONLY and nothing else.

At runtime, the evaluator application 642A replaces the bracketed variables (“{user_input}”, “{correct_answer}”, and “{application_answer}”) with the sample request 614A, correct response message, and agentic application response message, respectively, to format the prompt and submits the prompt to the first evaluator AI agent. The first evaluator AI agent may use one or more LMs to gather and parse the prompt and/or generate the metric score for the response. This process is repeated for each of the test cases 612A, . . . , 612N to generate a raw metric score for each response. The second evaluator AI agent may combine the raw metric scores for each response may be to generate an overall metric score for the agentic application. The process may be repeated for each metric included in the evaluation to generate an overall metric score for each performance metric. A third evaluator AI gent may combine the overall metric scores based on the metric weights to generate an overall performance score for the agentic application.

To determine scores for metrics 646A that require one or more tools, the orchestration components of the evaluator application 642A execute one or more plan and execution cycles. During each plan and execution cycle, the orchestration components may generate an evaluator agent call for an evaluator AI agent. The agent call may include a LM prompt formatted for the LM used by the receiving evaluator AI agent (e.g., an LLM prompt having the same content and format at the example LLM prompt above). For example, to determine a score for semantic similarity, the orchestration components may generate a first evaluator agent call for a first evaluator AI agent that maps to, evokes and runs a semantic distance tool that calculates, a semantic distance value (e.g., Levenshtein distance, distance between language embeddings, and the like) for the correct response message determined by a test function and an application response message for a test case. The orchestration components may determine a second evaluator agent call for a second evaluator AI agent that maps to, evokes, and runs a distance aggregation tool that determines one or more aggregate values for semantic distance based on the raw semantic distance values determined by the first evaluator AI agent. The orchestration components may to generate a third evaluator agent call for a third evaluator AI agent that maps to, evokes, and runs a data analysis tool that determines a score (on a predetermined numerical scale) for semantic distance based on the raw and or/aggregate semantic distances determined by the first and/or evaluator AI agents.

The evaluator application 642A may also use the evaluator AI agents 644A to determine overall scores for individual performance metrics 646A and agentic applications 220 using one or more tools. For example, the evaluator application 642A may determine an evaluator agent call for a first evaluator AI agent that maps to, evokes, and runs an overall metric score tool (e.g., a mathematical software package, API, and the like) that may determine an overall metric score for each metric. For example, the overall metric score tool may calculate the average value of all the raw metric scores for a particular metric to determine an overall metric score for the metric. The evaluator application 642A may also determine a second evaluator agent call for a second evaluator AI agent that maps to, evokes, and runs an overall performance score tool that may determine an overall performance score for an agentic application. The overall performance score tool may also use one or more predetermined methods of combining the overall metric scores to determine an overall performance score for an agentic application. For example, the overall performance score tool may determine a weighted average value for the performance metrics based on a set of predetermined and/or dynamic weights 648. To calculate the weighted average value, the overall performance score tool may determine the weighted sum of the overall scores for each metric by multiplying the overall score for each metric by the corresponding weight 648 for the metric to obtain a weighted overall score. The weighted overall scores for each metric may be added to calculate the weighted average value for the overall performance score. To return the performance score to the user, the evaluator application 642A may generate a third evaluator agent call for a third evaluator AI agent that uses an LM to generate a report that summarizes the results of the evaluation. The report may include a text string, list, table, graph, or other piece of content including the overall performance score for the agentic application, the overall metric scores for each metric, and/or the raw metric scores for each metric determined for each test case. The report may also include one or more lines of natural language text summarizing and/or analyzing the result of the evaluation.

To evaluate different types of agentic applications 220, different performance metrics 646A may be selected depending on the type of agentic application being evaluated. For example, users may configure the evaluation system 230 for specific agentic applications by selecting individual metrics to use for evaluation in one or more configuration interfaces provided by the interface component 210. To further customize evaluations, one or more weights 648 for each of the selected performance metrics 646A may be determined. The weights 648 may be used to tune the evaluation by weighting the overall scores for each of the individual metrics based on their importance to the overall performance of an agentic application. For example, to evaluate agentic applications used in a medical context (e.g., a diagnostic agent for determining if a patient has a particular condition, a first aid advice agent, a medical image analysis agent (e.g., a AI agent that reads and interprets CT scans or other medical images), and the like), the correctness metric may have a weight (e.g., 0.80) that is greater compared to a conciseness metric (0.06). One or more metric weights 648 may be determined by the evaluation system 230 and/or selected by users (e.g., specified in the configuration interfaces 210). To generate an overall performance score using metric weights, the overall metric score for each metric may be multiplied by the weight for the metric to generate a weighted metric score. The sum of the weighted metric scores may be calculated to determine an overall score for the application. In various embodiments, the configuration interface 210 may require that the weights 648 selected by users sum to 1.0, 100, or some other predetermined value to ensure the overall score determined by the evaluator application 642A is within a predetermined scale (e.g., between 0 and 1, between 0 and 100, and the like).

Users may also register custom metrics to make the performance evaluation more tailored to specific agentic applications. To register a custom metric, users may determine a custom test function for the custom metric. The custom test function may accept a correct response message and an application response message from an agentic application as inputs and return a score ranging from 0.0 to 1.0. Providing the function along with a name, to the evaluation system 230 will add the metric to the metric library available to the evaluator application 642A, . . . , 642N to use in subsequent evaluations of agentic applications 220. Optimal sets of domain specific weights for the metrics selected to evaluate different types of agentic applications 220 may be learned over time as described in more detail below. The domain specific weights may be different for different types of agentic applications to increase the specificity of performance evaluations made by the evaluation system 230.

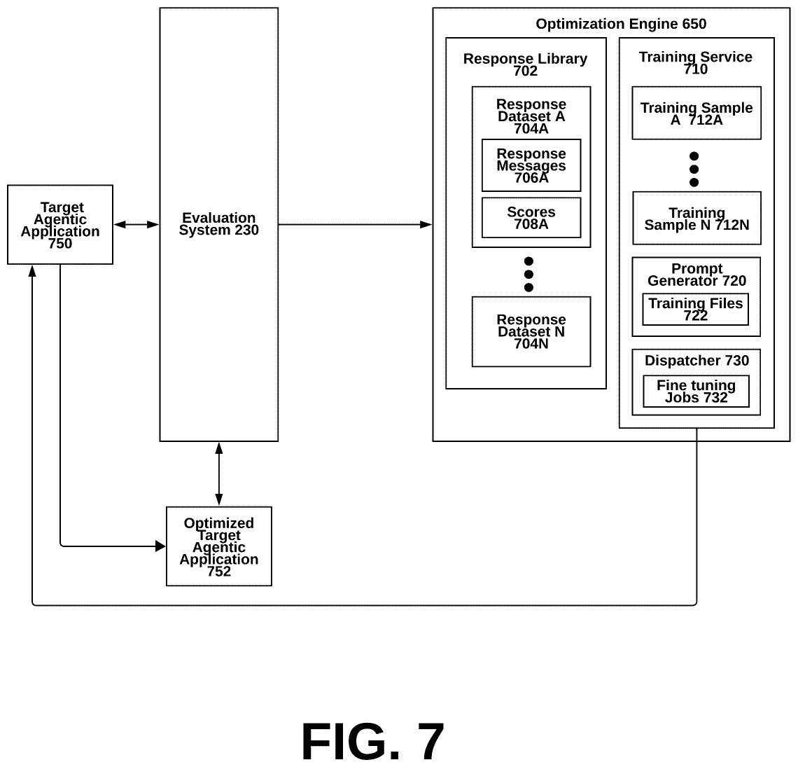

The evaluation system may also include an optimization engine 650 that may be used to improve the performance of agentic applications 220. As shown in FIG. 7, the optimization engine 650 may include a training service 710 that may improve the performance of application agents included in target agentic applications 750 that are not performing at or above a baseline performance threshold. The evaluation system 230 may determine baseline performance thresholds for individual metric performance and/or overall application performance using one or more agentic applications that have been previously tested and validated by the evaluation system. For example, the baseline thresholds may be determined by comparing the response messages generated by the validated applications to correct response messages determined by a test function for a series of sample requests that mimic the input request messages (e.g., user queries) the applications receive in production. In various embodiments, the sample requests may include actual input requests received from uses of the validated applications. The sample messages included in the test cases used to determine the performance threshold may be different for different types of agentic applications. For each validated application used to determine the thresholds, the evaluation system may determine an overall performance score and overall and/or raw metric scores for each metric receiving a baseline threshold. For example, the scores may include an overall performance score of 80 out of 100 and an individual metric scores of 80, 85, 90, 95, and 75 for the correctness, conciseness, helpfulness, ethics, and semantic similarity metrics, respectively. The overall performance score and/or overall metric scores for each validated application may combined (e.g., averaged) to calculate the overall performance threshold and metric threshold, respectively.

To test the performance of different types of agentic applications, the evaluation system 230 may determine performance and/or metric thresholds for validated agentic applications having different industry contexts, intended uses, model sizes, and the like. For example, applications intended for use in a medical context (e.g., a diagnostic assistant) may have higher metric thresholds for correctness and helpfulness relative to applications intended for use in an entertainment content (e.g., a celebrity clone chatbot). When evaluating an agentic application, the evaluation system may select the thresholds determined for applications having an particular industry and/or intended use that matches the application being evaluated. Users may also tune the evaluation system 230 for specific applications and their own user preferences by setting a specific required baseline overall performance threshold and/or metric thresholds that applications must achieve before they can be deployed to production. For example, users may select overall performance thresholds and/or metric threshold in a configuration UI provided by the interface component.

The optimization engine 650 may include a response library 702 that stores application response messages determined by agentic applications for sample requests and/or input request messages. The response library 702 may include one or more response datasets 704A, . . . , 704N that include one or more responses 704A (e.g., application response messages) and the scores 708A for each response determined by the evaluation system 230. The scores 708A may include grades for individual test cases and/or performance metrics as well as overall application performance scores and overall metric scores for individual performance metrics determined for multiple test cases. The response datasets 704A, . . . , 704N may be generated by associating and recording each application response 706A with respective scores 708A for the response. A response ID may be assigned to each application response that is recorded in the response library 702 so that specific response 706A may be located quickly.

The response datasets 704A, . . . , 704N may include the response messages 706A and scores 708A for a particular agentic application and/or groups of agentic applications that have one or more characteristics in common. For example, the response datasets 704A, . . . , 704N may include industry specific datasets that include response messages 706A and scores 708A for agentic applications that have a common industry context (e.g., applications that complete tasks in a particular industry such as, for example, healthcare, entertainment, productivity services, legal services, and the like). The response datasets 704A, . . . , 704N may also include response messages 706A and scores 708A from agentic applications that were trained at around the same time, have a similar LM size, type, and/or complexity, perform the same task, have the same goal, have a similar UI for interacting with users, have access to the same tools, and the like. The response datasets 704A, . . . , 704N may also include application response messages 706A that receive scores for one or more metrics that are above a predetermined metric score threshold. To generate different types of response datasets, an industry tag or tag for another relevant characteristic may be included in the response ID for application response messages that receive a score above a predetermined threshold and have a specific industry context or other characteristic.

Target agentic applications that are performing below a baseline performance level (e.g., receiving overall performance scores and/or metric scores that are less than respective performance and metric thresholds) may be identified using the evaluation system 230. The optimization engine 650 may improve the performance of the target agentic applications by re-training one or more LMs used by AI agents included in the target agentic application. The LMs s may be re-trained using one or more training samples 712A, . . . , 712N assembled from the response datasets 704A, . . . , 704N. The evaluation system 230 may identity a target agentic application 750 that is not achieving a baseline performance level based on the overall metric scores and/or the overall performance scores determined from a evaluation of the target agentic application. For example, the evaluation system 230 may compare the overall performance scores and/or overall metric scores determined for the target agentic application to a performance and/or metric score threshold for the application. Target agentic applications 750 that receive one or more scores that are below the score threshold may be identified as not achieving a baseline level of performance. The optimization engine 650 may re-train one or more LMs used by AI agents included in the target agentic application 750 to improve the performance of the application.

In various embodiments, the optimization engine 650 may re-train one or more LMs used by AI agents of the target agentic application 750 to improve the performance of the application in a specific area. For example, the optimization engine 650 may re-train an LM to make the responses generated the target agentic application 750 more concise or improve the scores for one or more other performance metrics. To improve the performance of target agentic applications 750 for a specific target metric, the training service 710 may assemble a training sample 712A that includes responses that received high scores for the target metric. For example, the optimization engine 650 may build a training sample 712A for a target agentic application 750 that has low scores (e.g., below threshold) for conciseness (e.g., generates response messages that are relevant but too long) by selecting agent response messages 706 generated by applications in the same industry and/or having the same intended use as the target agentic application 750 that received high scores for the conciseness metric (e.g., scores above a certain score threshold (e.g., 90). In various embodiments, the training service 710 may also assemble the conciseness training sample for the target agentic application 750 by selecting response messages receiving scores in the top 10% of all responses generated by applications having a specific industry or intended use (e.g., . . . , response messages receiving scores for conciseness in the top 10% of all response messages generated by applications in medical industry).

To improve the overall performance of a target agentic application 750 to the training service 710 train one or more LMs used by AI agents included in the application on a training sample 712A that includes response messages generated by agentic applications in the same industry and/or having the same intended use that received high overall performance scores (e.g., scores above a certain score threshold (e.g., 90). The training service may also build a training sample 712 for re-training LMs used by a target agentic application 750 with low overall performance scores (e.g., overall performance scores below the overall performance baseline) by selecting response messages with overall performance scores that are in the top 10% of response messages generated by all applications having the same industry or indented use as the target agentic application (e.g., response scores the top 10% of scores for all response messages generated by applications in the medical industry.

To improve the success rate for the re-training process, the training samples 712A, . . . , 712N may include responses from applications that have one or more characteristics in common with the target agentic application 750. For example, that training service 710 may build training samples 712A, . . . , 712N for LMs in a target agentic application 750 using response messages generated by applications that were trained at around the same time, are used in same industry, perform the same task, having similar numbers of AI agents, include LMs having a similar size, type, and/or complexity, and the like.

A prompt generator 720 may format the training samples 712A, . . . , 712N into training files 722 that include the response message selected by the training service 710 and the LM prompt used to generate each response message. The LM prompt may include a list of messages in a conversation that includes the response message and the sample request and/or input request message used to generate the response. Each message may be formatted to have a role (e.g., user, system, and the like) and content (e.g., lines of text included in the sample request and/or input request message or the response message). The LM prompt for each response may also be formatted by the prompt generator 720 as a prompt and completion pair that includes the sample request message and/or input request message as the prompt and the response message from the high performing application as the completion. The prompt generator 720 may aggregate the LM prompts for the responses in the training samples 712A, . . . , 712N into a training file 722. The prompt generator 720 may also format the training file 722 to be received by the target agentic application 750. The training file 722 may also include a description of the LM prompts and the objective of re-training the LMs on the training file 722. For example, the description may include, “the LM prompts in the training sample include example responses that received high scores for the conciseness metric” and the objective may include “the LM prompts in the training sample are intended to make the responses generated by the LM more concise”. The training file 722 may also include instructions for re-training the LM used by the AI agents in the agentic application, for example, “generate a concise response for the sample request using the example responses receiving high scores for the conciseness metric as the basis for generating the response”. A dispatcher 730 may generate one or more fine tuning jobs 732 for the training files 722 that display the LM prompts in each file to an LM associated with the target agentic application 750 (e.g., a LLM used by an AI agent included in the target agentic application). The fine tuning jobs 732 may re-train one or more LMs by modifying a language embedding space of the LM that is associated with a target metric and/or overall application performance based on the requests and responses included in the training file 722. The one or more LMs modified during re-training may stored and an optimized target agentic application 752 may be built using the re-trained LMs. For example, an optimized AI agent may be configured to use the re-trained LMs to generate response messages and the optimized AI agent may replace the original AI agent in the target agentic application 750 to generate an optimized target agentic application 752.

In various embodiments, the fine tuning jobs 732 may divide the LM prompts included in the training file 722 into a training portion and a testing portion. The training portion may include a sample (e.g., 75%, 80%, or some other predetermined proportion or number) of the response messages (e.g., the training examples). One or more LMs used by AI agents in target agentic application 750 may be re-trained may ingesting the training examples. For example, the training examples may be displayed to the LMs to improve the understanding of the LMs of one or more metrics where the training examples achieved scores above baseline. For example, to improve the target agentic application understanding of conciseness, a training example of response messages receiving high scores for conciseness and the request messages used to generate the responses (e.g., the training examples) may be ingested by an LM used by an AI agent of the application. The fine-tuning jobs may use the training examples to train the LM by adjusting one or more parameters of the LM based on the training examples to modify one or more language embeddings and/or the embedding space associated with the term conciseness. An optimized AI agent may be configured to use the re-trained LM and the optimized AI agent may replace the original AI agent in the target agentic application 750 to generate an optimized target agentic application 752.

The test portion may include the remaining portion of the training file (e.g., the remaining sample of example response and request messages that were not included in the training portion). To test the performance of the optimized target agentic application 752, each request message in the test portion (e.g., test request message) may be input into the application to generate a response message. The evaluation system 230 may evaluate the performance of the optimized target agentic application 752 by comparing the response messages generated by the optimized target agentic application 752 for each test request to the original response message for the test request from the training file 722. The evaluation system 230 may use one or more target metrics as the basis for the evaluation to determine if the training process was able to improve the performance of the optimized target agentic application 752 for the specific target metrics where the target agentic application 750 was determined to be deficient (e.g., was generating responses that received scores below baseline). The scores for each target metric for every sample request and/or input request message included in the test sample may be aggregated and used to determine an overall metric score and/or overall performance score for the optimized target agentic application 752. The optimization engine 650 may compare the overall metric score and/or overall performance score to the respective overall performance score and/or metric score thresholds for the target agentic application 750. If the overall metric score and/or overall performance score for the test sample meets or exceeds the metric score and/or performance score threshold, the optimized target agentic application 752 may be deployed to production. If the overall metric score and/or overall performance score for the test sample is below the metric score and/or overall performance score threshold, the optimization engine 650 may re-train one or more LMs associated with the optimized target agentic application 752 again using the training service 710 until an optimized version of the target application is able to achieve scores for a test sample that meet or exceed the score thresholds for each target metric and/or overall performance.

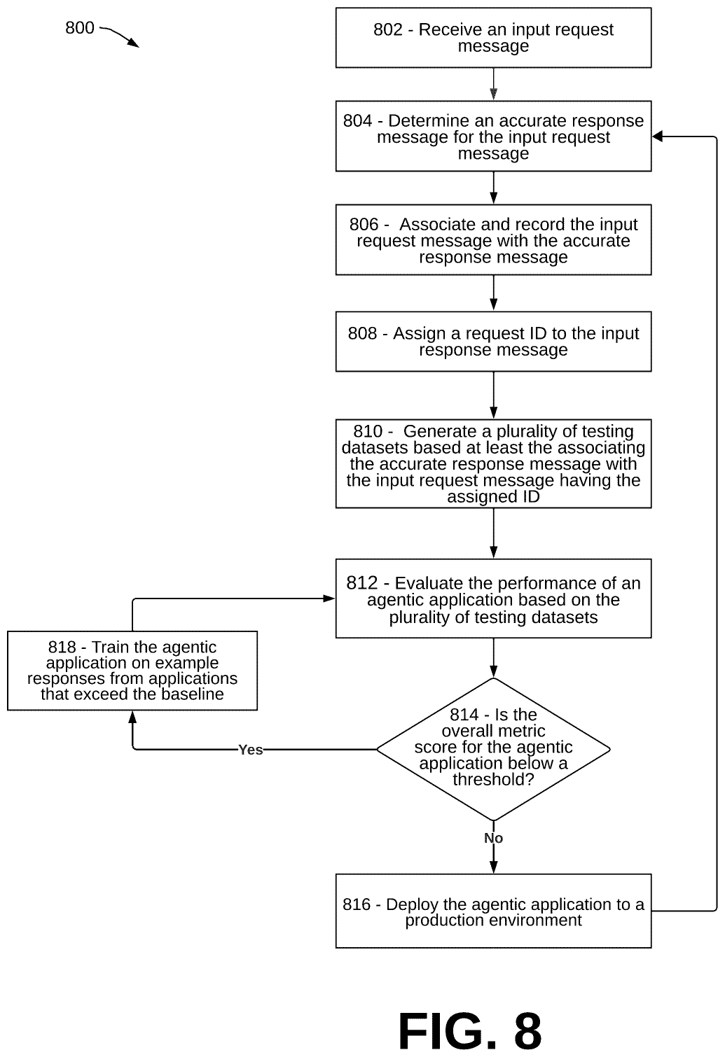

Some present examples also include methods. FIG. 8 is a block diagram of a process 800 of evaluating an agentic application. In various embodiments an evaluation system may be used to evaluate the performance of agentic applications when completing specific user requests. For example, the evaluation system may be used to determine how an agentic application performs when handling requests having an industry context (e.g., healthcare related tasks, entertainment activities, personal assistant jobs, legal services advice, and the like). At step 802, the evaluation system (e.g., an evaluation system implemented in a testing server) may receive an input request message from a user (e.g., a user of one or more customer devices). At step 804, a test function may be used to determine an accurate response message for the input request message. At step 806, the evaluation system may associate and record the input request message with the accurate response message.

The evaluation system may record the associated message and response pair in a testing library or other database. The testing library may include test cases having sample requests and test functions used to determine accurate responses for the sample requests. Characteristics of agentic applications (e.g., industries, intended users, types of tasks they perform, risk level of the tasks they perform, complexity of the tasks they perform, number of AI agents they use, size of the LM used by the AI agents, technical specifications (e.g., response time, latency, inference cost, and the like), and the like may be associated with the request IDs assigned to test cases to enable groups of sample requests having a particular industry or other application characteristic to be selected quickly. At step 808, the evaluation system may assign a request ID to the input request message. The input request message and the corresponding test function may be stored as a test case associated with the assigned request ID.

At step 810, the evaluation system may generate a testing dataset used to test the performance of an agentic application. The testing dataset may include multiple test cases. The testing dataset may be generated by associating the accurate response message with the input request message having the assigned ID. For example, the evaluation system may generate a testing dataset that is specific to one or more input request messages including in a test case to test how well the agentic application performs for requests that are similar to the request included in the input request message. The evaluation system may generate the testing dataset by selecting test cases based on one or more evaluation parameters. For example. The evaluation system may select test cases that include multiple sample requests having an industry context, request characteristic (e.g., request type, task type, message length, and the like) in common with the input request message, and/or application characteristic in common with the agentic application being evaluated. The evaluation parameters used to generate the testing dataset may be specified by users in the test request message. The test functions for each of the selected test cases may then be used to dynamically determine accurate response messages for each of the multiple sample requests. Each of the multiple sample requests and the input request message along with their respective accurate response messages may be aggregated in a testing dataset.

At step 812, the evaluation system may evaluate the performance of an agentic application based on the plurality of testing datasets. The evaluation system may display the input request message and the multiple sample requests to the agentic application and receive an application response message for each request from the agentic application. One or more evaluator agentic applications of the evaluation system may use one or more evaluator AI agents to determine a score for each application response message. The evaluator AI agents may determine the scores by using one or more tools and/or LMs to compare each application response of the application responses to a corresponding correct response message of the correct response messages included in the testing dataset. The evaluator agentic application may use a different evaluator AI agent to determine a metric score for each performance metric. The evaluator AI agent for each performance metric used in the evaluation may determine a metric score for each application response message that grades the application response message based on a particular performance metric. The performance metrics to include in the evaluation may be specified in the test request messages.

A second evaluator AI agent (e.g., an aggregator AI agent) may determine an overall metric score for the agentic application based on the individual metric scores for each of the application response messages. For example, the aggregator AI agent may determine the overall metric score by averaging the raw metric scores determined for each individual application response message. To facilitate determining an overall performance score for the agentic application that is based on multiple performance metrics, an evaluator AI agent may determine an overall metric score based on one or more metric weights included in the test request message. The overall metric scores may be weighted based on the importance to the overall performance of the agentic application, the weighted overall metric score may be calculated multiplying the raw overall metric score by a weight for the performance metric. A third evaluator AI agent may determine an overall performance score for the agentic application by calculating the sum of the weighted overall metric scores.

At step 814, the overall metric score and/or the overall performance score may be compared to a performance baseline. For example, the overall metric score for each performance metric selected for the evaluation may be compared to a metric score threshold to determine if the agentic application is performing up to a predetermined baseline level for each performance metric (e.g., a baseline level of performance required to deploy the agentic application in a production environment). The metric score threshold may be different for each performance metric and/or each agentic application. The overall performance score may be compared to an overall performance score threshold to determine if the agentic application is achieving a level of overall performance required for deployment. The overall performance score threshold may be different for each agentic application. For example, the score threshold may be determined based on the characteristics (e.g., industries, intended uses, tasks performed, technical specifications of LMs used by AI agents included in the applications, and the like) of the agentic application being evaluated.

To determine an overall performance score for evaluations that include multiple metrics, an evaluation system may receive a set of performance metrics including multiple performance metrics. The performance metrics may be selected by the user, for example, within a configuration UI and included in a test request message. The set of performance metrics may be displayed to the evaluator agentic application. Overall metric scores for each performance metric may be received from the evaluator agentic application. The evaluation system may determine an overall performance score for the agentic application by determining a weighted average of the overall metric scores for each of the metrics used in the evaluation. To calculate the weighted average, the evaluation system may receive a weight for each performance metric included in the set of performance metrics selected for an evaluation. The evaluation system may use the weights and overall metric score to determine the weighted average. For example, the evaluation system may multiply the overall metric score by the weight determined for the metric to determine a weighted metric score. The sum of weighted metric scores may be calculated to determine the overall performance score for the agentic application.

If, at step 814, the overall metric score and/or overall performance score is below the respective metric and/or performance score threshold (no at step 814), the agentic application may be deployed to a production environment, at step 816. If, at step 814, the overall metric score and/or overall performance score is below the respective metric and/or performance score threshold (yes at step 814), the agentic application may be trained, at step 818, to improve the performance of the application. The optimized agentic application trained using the training process performed by the optimization engine may be re-evaluated, at step 812, to determine if the training process was able to improve the application's performance. The overall metric scores and/or overall performance scores determined for the optimized agentic application may be compared to their respective score thresholds at step 814 to determine if the optimized agentic application is ready to be deployed to production. Optimized agentic applications that do not achieve at least the baseline level of performance may be trained and evaluated again (e.g., by repeating steps 818 and 812-814) until an optimized agentic application that achieves the metric and/or performance score thresholds is generated.

To train agentic applications at step 818, one or more LMs used by AI agents included in the agentic applications may be re-trained using a training file. The training files used to re-train the LMs may be different for each agentic application and each of the training files may include example responses that achieved high scores when evaluated by the evaluation system. For example, the training files may include responses that achieved an overall metric score and/or an overall performance score that meets or exceeds a score threshold. To facilitate selecting the example response to include in the training files, the score for each of the application response messages may be associated and recorded with its corresponding application response message and a response ID may be assigned to application response messages that achieve a score above a score threshold. The training files may be generated by associating a score above the score threshold with the application response message assigned a response ID. One or more characteristics of the response, agentic application, and/or LMs used by the AI agents of the agentic application may be associated with the response ID to enable responses with specific characteristics and/or responses generated by applications and/or LMs having specific characteristics to be selected for training files. Training files may be generated by selecting response IDs for a portion of the application responses that have one or more target characteristics (e.g., a particular metric, industry context, minimum performance score, user, and the like). For example, training files for a target agentic application that provides medical advice may be generated by selecting response IDs for response messages generated by agentic applications having a medical context (e.g., an intended use in the medical industry). The training files for the medical advice target application may be further refined by selecting, from the pool of selected response IDs with a medical context, response IDs for application response messages having a particular range of metric scores. For example, if the target medical advice agentic application receives a score for a correctness metric that is below a metric score threshold for the correctness metric, the training files for the application may be generated by selecting a portion of the selected response IDs with a medial context that received scores for the correctness metric that were above a metric score threshold (e.g., above 85, in the top 10% of scores, response IDs having the highest 100 scores, and the like).

The training files may include a training portion and a testing portion. The training and testing portions may be formatted to be received by an LM used by AI agents included in the target agentic application. The training portion may include a first set of response completion pairs that each include a selected application response message and a sample request message and/or user request message linked to the response (e.g., used to generate the response). The testing portion may include a second set of response completion pairs that include other selected application responses and a sample request message and/or user request message used to generate each application response. The second set of request completion pairs may be different from (e.g., not included in) the first set of response completion pairs so that the agentic application will not be exposed to the requests in the testing portion during training on the training portion.

To use the training file, a target agentic application may be identified based on receiving an overall metric score and/or overall performance score that is below a respective metric score and/or performance score threshold. The training file may be dispatched to target agentic application and each of the request completion pairs in the training portion may be displayed to the LM used by the AI agent in the target agentic application that is being re-trained. The LM may receive the displayed request completion pairs and modify a language embedding space of the LM that is associated with a particular performance metric and/or overall performance evaluation based on the displayed request and completion pairs. Modifying the language embedding space of the LM may enhance the LM's understanding of a particular performance metric and/or overall performance evaluation and enable the agentic application to generate application responses that are more in line with responses that achieve a metric and/or overall scores that are above threshold. An optimized target agentic application may be generated by configuring an AI agent in the target agentic application to access and use the re-trained LM with the modified language embedding space to generate an optimized AI agent. The optimized AI agent may replace the original AI agent in the target agentic application to generate an optimized target agentic application.

The optimized target agentic application may be tested using the testing sample to determine if the training on the training portion was effective. The optimized target agentic application may be tested by displaying each sample request message and/or user request message included in the testing portion to the optimized target agentic application. A test application response for each displayed request may be received from the optimized target agentic application. A score for each test application response may be determined by the evaluator agentic application. The test application response scores may be determined by comparing each test application response generated for the requests included in the test portion to the corresponding response from the request completion pairs. A new overall metric and/or performance score for optimized target agentic application may be determined based on the scores determined for each test application response. The performance of the optimized target agentic application may be tested by comparing the new overall metric and/or performance score to a corresponding metric and/or performance score threshold.

The re-training process for the LMs used by the AI agents included in the optimized target agentic application my continue until the performance of the optimized target agentic application achieves a baseline level of performance (e.g., the overall performance score and/or overall metric score meets or exceeds the overall performance score and/or overall metric score threshold). The target agentic application may also be continuously trained by re-training the LMs used by the AI agents on new sample requests in order to continuously improve the performance of the target agentic application over time.

In this disclosure, the following definitions may apply in context. A “Client Device” or “Electronic Device” refers to any machine that interfaces to a communications network to obtain resources from one or more server systems or other client devices. A client device may be, but is not limited to, a mobile phone, desktop computer, laptop, portable digital assistant (PDA), smart phone, tablet, ultra-book, netbook, laptop, multi-processor system, microprocessor-based or programmable consumer electronic system, game console, set-top box, or any other communication device that a user may use to access a network.

“Communications Network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and coupling may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

“Component” (also referred to as a “module”) refers to a device, physical entity, or logic having boundaries defined by function or subroutine calls, branch points, application programming interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors.

It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instant in time. For example, where a hardware component includes a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instant of time and to constitute a different hardware component at a different instant of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Image data” in this context refers to any type of visual media or other data that includes a number of rows and columns or pixels including, for example, images, frames of video, three dimensional holograms, pixel data, virtual reality (VR) content, augmented reality (AR) content, mixed reality (MR) content, extended reality (XR) content, and the like.

“Machine-Readable Medium” in this context refers to a component, device, or other tangible medium able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EPROM)), and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“Processor” refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), or any combination thereof. A processor may further be a multi-core processor having two or more independent processors (sometimes referred to as “cores”) that may execute instructions contemporaneously.

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

Although the subject matter has been described with reference to specific example embodiments, it will be evident that various modifications and changes may be made to these embodiments without departing from the broader spirit and scope of the disclosed subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Description, therefore, is not to be taken in a limiting sense, and the scope of various embodiments is defined only by any appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system for evaluating agentic applications comprising:
an application server configured to operate and manage one or more agentic applications;
a plurality of customer devices configured to provide input request messages; and
a testing server electronically connected to the application server and the plurality of customer devices, the testing server configured to:
receive a test request message including one or more evaluation parameters;
determine a set of test cases of an agentic application based on the test request message, the test cases including multiple sample requests and a test function for each of the multiple requests;
dynamically generate an accurate response message for each sample request based on the test function;
display the multiple sample requests to the agentic application;
receive, from the agentic application, an application response message for the input request message and the sample requests;
select an evaluator application for the agentic application based on the one or more evaluation parameters and one or more characteristics of the agentic application;
determine a raw metric score for each application response message using the evaluator application, the raw metric score determined by comparing each application response message to a corresponding accurate response message using a performance metric as a basis for the comparison; and
determine an overall metric score for the agentic application based on the raw metric scores for each of the application response messages and a weight for the performance metric.

2. The system of claim 1, wherein the testing server is further configured to associate and record the raw metric scores with each of the application response messages; and
assign a response ID to each application response message that receives a raw metric score above a predetermined threshold.

3. The system of claim 2, wherein the testing server is further configured to identify a target agentic application receiving an overall metric score for the performance metric that is below a score threshold;
re-train a language model (LM) used by an artificial intelligence (AI) agent included in the target agentic application;
configure the AI agent to use the re-trained LM to generate an optimized AI agent; and
build an optimized target agentic application by replacing the AI agent in the target agentic application with the optimized AI agent.

4. The system of claim 3, wherein the LM is re-trained using a training sample that includes one or more sample requests and one or more response messages generated for the one or more sample requests that received a metric score for the performance metric that is above the score threshold.

5. The system of claim 4, wherein the testing server is further configured to divide the training sample into a training portion used to re-train the LM and a testing portion used to validate the performance of the optimized target agentic application.

6. The system of claim 1, wherein each of the multiple sample requests includes a request message that prompts the agentic application to perform a task.

7. The system of claim 1, wherein the testing server is further configured to validate the agentic application for deployment to a production environment based on the overall metric score.

8. The system of claim 1, wherein the testing server is further configured to receive a set of performance metrics including multiple performance metrics selected by the user;
display the set of performance metrics to the evaluator agentic application; and
receive overall metrics scores for each performance metric from the evaluator agentic application.

9. The system of claim 8, wherein the testing server is further configured to receive a weight for each performance metric included in the set of performance metrics; and
determine an overall performance score by calculating a weighted overall metrics score based on the overall metric score and the weight for each of the performance metrics.

10. The system of claim 1, wherein the score for each application response message is determined by generating an agent call that includes an LM prompt formatted for an evaluator AI agent included in the evaluator agentic application, the LM prompt including a mapping between an action included in the LM prompt and a tool used to complete the action and a software script for evoking and running the tool;
displaying the LM prompt to the evaluator AI agent;
receiving, from the evaluator AI agent, an evaluation metric calculated using the tool; and
determining the score based on the evaluation metric.

11. A method for evaluating agentic applications comprising:
receiving a test request message including one or more evaluation parameters;
determining a set of test cases of an agentic application based on the test request message, the test cases including multiple sample requests and a test function for each of the multiple requests;
dynamically generating an accurate response message for each sample request based on the test function;
displaying the multiple sample requests to the agentic application;
receiving, from the agentic application, an application response message for the input request message and the sample requests;
selecting an evaluator application for the agentic application based on the one or more evaluation parameters and one or more characteristics of the agentic application;
determining a raw metric score for each application response message using the evaluator application, the raw metric score determined by comparing each application response message to a corresponding accurate response message using a performance metric as a basis for the comparison; and
determining an overall metric score for the agentic application based on the raw metric scores for each of the application response messages and a weight for the performance metric.

12. The method of claim 11, further comprising associating and recording the raw metric scores with each of the application response messages; and
assigning a response ID to each application response message that receives a raw metric score above a predetermined threshold.

13. The method of claim 12, further comprising identifying a target agentic application receiving an overall metric score for the performance metric that is below a score threshold;
re-training a language model (LM) used by an artificial intelligence (AI) agent included in the target agentic application;
configuring the AI agent to use the re-trained LM to generate an optimized AI agent; and
building an optimized target agentic application by replacing the AI agent in the target agentic application with the optimized AI agent.

14. The method of claim 13, wherein the LM is re-trained using a training sample that includes one or more sample requests and one or more response messages generated for the one or more sample requests that received a metric score for the performance metric that is above the score threshold.

15. The method of claim 14, further comprising dividing the training sample into a training portion used to re-train the LM and a testing portion used to validate the performance of the optimized target agentic application.

16. The method of claim 11, wherein each of the multiple sample requests includes a request message that prompts the agentic application to perform a task.

17. The method of claim 11, further comprising validating the agentic application for deployment to a production environment based on the overall metric score.

18. The method of claim 11, further comprising receiving a set of performance metrics including multiple performance metrics selected by the user;
displaying the set of performance metrics to the evaluator agentic application; and
receiving overall metrics scores for each performance metric from the evaluator agentic application.

19. The method of claim 18, further comprising receiving a weight for each performance metric included in the set of performance metrics; and
determining an overall performance score by calculating a weighted overall metrics score based on the overall metric score and the weight for each of the performance metrics.

20. The method of claim 11, wherein the score for each application response message is determined by generating an agent call that includes an LM prompt formatted for an evaluator AI agent included in the evaluator agentic application, the LM prompt including a mapping between an action included in the LM prompt and a tool used to complete the action and a software script for evoking and running the tool;
displaying the LM prompt to the evaluator AI agent;
receiving, from the evaluator AI agent, an evaluation metric calculated using the tool; and
determining the score based on the evaluation metric.
